(19) United States
(12) Patent Application Publication
(10) Pub. No.: US 2015/0048096 A1
(43) Pub. Date: Feb. 19, 2015

(54) BOX FOR KEEPING FOOD AND DRINK TEMPERATURE

(71) Applicant: Oren SHADMI, Kibbutz Nir David (IL)

(72) Inventor: Oren Shadmi, Kibbutz Nir David (IL)

(21) Appl. No.: 14/371,095

(22) PCT Filed: Jan. 7, 2013
(86) PCT No.: PCT/IL2013/000001

§ 371 Date: Jul. 8, 2014

(30) Foreign Application Priority Data
Jan. 8, 2012 (IL) 217430

(51) Int. Cl. A47J 47/14; A47J 41/00; A47J 39/00

(52) U.S. Cl. CPC A47J 47/145; A47J 39/00; A47J 41/00
USPC 220/592.01

(57) ABSTRACT

Chilled food, frozen food at low temperatures that retain food quality outside of the source of cold, and retaining hot food in the Wonder Boxes—preserving food in the Wonder Boxes after their removal from the source of heat. All of this, using appropriate Wonder Boxes with two panels or more, with water or another substance in between. The idea underlying the development of the Wonder Boxes is to allow students, who take sandwiches prepared in the morning and eaten at lunchtime, proper preservation. Another example is in the purchase of frozen or chilled food at the market and bringing it to the refrigerator at home only several hours later. Purchasing hot food, bringing it home and eating it hot. Prevents reheating. In our modern world, we do not enable manufacturers and distributors to transport chilled or frozen food without proper refrigeration. Anyone who does so, is immediately subject to shipment disqualification. We enable students and consumers the ability to do so because there is nothing to protect them except for ice boxes and thermoses which, due to their size and weight, are not very popular—justifiably so. In addition, an ice box is not suitable for a small helping or a single box of food. Wonder Boxes aim to solve these problems because they are light, small, appropriate for food and drink, and easy to operate. In order to retain the quality of food which being left outside a source of cold or heat, Chilled food, frozen food or hot food preserved in boxes after their removal from the source of heat, using appropriate boxes with two panels or more, with water or another substance in between. The idea is to allow students, who take sandwiches prepared in the morning and eaten at lunchtime, proper preservation. Another example is in the purchase of frozen or chilled food at the market and bringing it to the refrigerator at home only several hours later.

Wonder Boxes—Refrigerated or heated preservation of sandwiches, chilled food, frozen food, at low temperatures that maintain food quality outside of the cooling source and preserving hot food in boxes for a short while after removal from the heat source. All of this is achieved with appropriate boxes with double sides or more, containing regular water or an appropriate substance.

There are several methods for keeping food and/or water cold or hot in the wonder boxes

1) There are several options for placing unpackaged food or beverages directly into the Wonder Boxes.
A) Place the food or beverage into the Wonder Box after it had been in a source of cold or heat.
B) Place the food or beverage into the Wonder Box and then place them into the source of cold or heat, to be removed at the appropriate time.
C) The two options can be combined.

2) There are several options for placing food in the Wonder Boxes in their regular container:
A) Place the Wonder Box into the source of heat or cold, remove them from the source of heat or cold at the appropriate time and place the food or beverage, in their regular container, into the Wonder Box.
B) Place the food or beverage, in their regular container, in the Wonder Box and place them into the source of heat or cold together, to be removed at the appropriate time.
C) The two options can be combined.

3) Product offers a source of cold or hot drinking water. The water or beverage between the box panels are potable beverages.

4) Option of adding wax, baking or other paper within the Wonder Boxes to protect them against the development of harmful bacteria and, if any appear, it eradicates them.

5) Ability to determine whether the food is good or bad thanks to labels on the boxes.

6) The Wonder Box can be wrapped or, alternately, there is a substance on the external coating of the box to enable transporting the Wonder Boxes from the source of cold or heat without the person carrying them feeling the heat or cold and without causing harm to other products, i.e. in his bag, he can use one to keep the heat or cold.
The idea underlying the development of the Wonder Boxes is to allow students, who take sandwiches prepared in the morning and eaten at lunchtime, proper preservation. Another example is in the purchase of frozen or chilled food at the market and bringing it to the refrigerator at home only several hours later.
Purchasing hot food, bringing it home and eating it hot. Prevents reheating. In our modern world, we do not enable manufacturers and distributors to transport chilled or frozen food without proper refrigeration. Anyone who does so, is immediately subject to shipment disqualification.

We enable students and consumers the ability to do so because there is nothing to protect them except for ice boxes and thermoses which, due to their size and weight, are not very popular—justifiably so.

In addition, an ice box is not suitable for a small helping or a single box of food. Wonder Boxes aim to solve these problems because they are light, small, appropriate for food and drink, and easy to operate.

1) An apparatus comprising a box including two or more sides containing water or a substance that preserves heat or cold in the box, said box enabling the retention of cold or hot food or a beverage within the after removing the box from a source of cold or heat.

2) A method for placing unpackaged food or a beverage directly into box of claim 1, the method comprising:
A) Placing the food or the beverage into the box after the box was in the source of cold or heat; or.
B) Placing the food or beverage into the box and then put the box into the source of cold or heat, to be removed at the appropriate time; or
C) options A and B can be combined.

3) A method for placing food in a regular container in the box of claim 1, comprising:
A) Placing the box into the source of heat or cold, removing the box from the source of heat or cold and placing the food or beverage, in the regular container, into the Box; or
B) Placing the food or beverage, in the regular container, in the x box and placing the box into the source of heat or cold together, to be removed at the appropriate time; or
C) options A and B can be combined.

4) A method of using the apparatus of claim 1, comprising drinking the water or substance.

5) The apparatus of claim 1, further including wax paper within the box.

6) The apparatus of claim 1, further including a label on the box for enabling one to determine whether the food is good or bad.

7) (canceled)

8) The apparatus of claim 1, wherein the box is wrapped or, alternately, there is a substance on the external coating of the box to enable transporting the box from the source of cold or heat without the person carrying them feeling the heat or cold and without causing harm to other products.
